(19) United States
(12) Patent Application Publication
(10) Pub. No.: US 2026/0180026 A1
(43) Pub. Date: Jun. 25, 2026

(54) GEL POLYMER ELECTROLYTE, LITHIUM BATTERY COMPRISING THE SAME, AND METHOD FOR PREPARING THE SAME

(71) Applicant: Academia Sinica, Taipei City (TW)

(72) Inventors: Maw-Kuen WU, Taipei City (TW); Yan-Reui CHEN, Taipei City (TW); Liang-Yu CHEN, Taipei City (TW); Chin-Yi CHUNG, Taipei City (TW); Hsung-Ming HSU, Taipei City (TW); Po-Wei CHI, Taipei City (TW); Phillip M. WU, Taipei City (TW)

(21) Appl. No.: 19/424,502

(22) Filed: Dec. 18, 2025

Related U.S. Application Data
(60) Provisional application No. 63/737,883, filed on Dec. 23, 2024.

(51) Int. Cl. H01M 10/0565; H01M 4/02; H01M 4/38; H01M 4/525; H01M 4/58; H01M 10/052

(52) U.S. Cl. CPC H01M 10/0565; H01M 4/382; H01M 4/525; H01M 4/5825; H01M 10/052; H01M 2004/027; H01M 2004/028; H01M 2300/0082

(57) ABSTRACT

Disclosed is a gel polymer electrolyte, comprising: a cross-linked composition formed by pectin, its derivative or a combination thereof; a polyol; and a lithium salt. Also disclosed is a lithium battery comprising the same and a method for preparing the same.

### CROSS-REFERENCE TO RELATED APPLICATIONS

This application claims the benefit of filing date of U.S. Provisional Application Ser. No. 63/737,883, filed Dec. 23, 2024 under 35 USC § 119(e)(1).

### BACKGROUND OF THE INVENTION

### Field

The present invention relates to a gel polymer electrolyte, a lithium battery comprising the same, and a method for preparing the same. More specifically, the present invention relates to a gel polymer electrolyte formed by pectin and polyol, a lithium battery comprising the same, and a method for preparing the same.

### Description of Related Art

It has become an urgent need to use non-liquid electrolytes in lithium-ion batteries (LIBs) in order to enhance their safety, energy density, and longevity. The solution to mitigate dendrite growth, ensure electrolyte stability, improve ionic conductivity, and maintain robust interfacial compatibility are challenges to the research community. To address these difficulties, gel polymer electrolytes (GPEs) or solid polymer electrolytes (SPEs) are potential candidates to effectively prevent dendrite growth. GPEs can effectively suppress the dendrite growth and interfacial stability and show additional significant enhancement in ionic conductivity, broad electrochemical window, and excellent interfacial compatibility with electrodes. However, challenges such as low ionic transfer numbers, poor mechanical strength, and inadequate thermal stability persist.

Recent advancements in GPEs have focused on enhancing these properties through strategies such as immobilizing anion movement, creating ion transport pathways, incorporating nano-fillers, and designing crosslinked structures. SPEs and GPEs, with embedded ionic species within a polymer matrix, offer flexibility, enhanced safety, and conformability to device shapes that are especially beneficial for thin-film batteries and flexible applications.

Numerous studies have been conducted on batteries. Despite the development of numerous materials, their non-recyclable nature limits their use. Thus, it is desirable to provide a novel hydrolytically recyclable gel electrolytes.

### SUMMARY OF THE INVENTION

The present invention provides a gel polymer electrolyte, comprising a cross-linked composition formed by pectin, its derivative or a combination thereof; a polyol; and a lithium salt. More specifically, the gel polymer electrolyte comprises a polymer matrix formed by the pectin, its derivative or a combination thereof; and the polyol, with ionic species derived from the lithium salt embedded in the polymer matrix.

The present invention also provides a lithium battery comprising the aforesaid gel polymer electrolyte.

The present invention further provides a method for preparing the aforesaid gel polymer electrolyte.

Other novel features of the disclosure will become more apparent from the following detailed description when taken in conjunction with the accompanying drawings.

### BRIEF DESCRIPTION OF DRAWINGS

FIG. 1 displays the stress-strain curves of PP275 when combined with different Li salts.

FIG. 2 shows TGA curves of the PPLMs.

FIG. 3 shows DSC curves from 30° C. to 700° C. at a heating rate of 5° C./min under an N₂ atmosphere.

FIG. 4 shows LSV curves recorded at room temperature.

FIG. 5 shows Arrhenius plot of PPLMs across a temperature range of 40° C.-75° C.

FIG. 6 shows overpotential of the symmetric Li∥PPLMs∥Li cell at various current densities.

FIG. 7 shows discharge capacities of PPLMs cells at a 0.5 C rate.

FIG. 8 shows voltage profiles for LNO-025 cells at 0.5 C.

FIG. 9 shows discharge capacities and Coulombic efficiency of LNO-025 cells at 1 C/3 C, followed by a return to 0.1 C.

FIG. 10 shows voltage profiles for LNO-025 cells at 1 C/3 C.

FIG. 11 shows voltage profiles for LNO-025 cells returning to a 0.1 C rate.

FIG. 12 shows rate capability of the Li∥PPLMs∥LFP cells.

### DETAILED DESCRIPTION OF THE INVENTION

Disclosed in detail below is a gel polymer electrolyte, comprising a cross-linked composition formed by pectin, its derivative or a combination thereof; a polyol; and a lithium salt, which can be used as an electrolyte for lithium batteries.

In one embodiment, the cross-linked composition formed by the pectin; the polyol; and the lithium salt.

In the aforesaid embodiment, the pectin, its derivative or a combination thereof comprises an uronic acid monomer.

In the aforesaid embodiments, the polyol has a molecular weight (g/mol) of 100 to 2000, 100 to 1800, 100 to 1500, 100 to 1300, 100 to 1000, 100 to 900, 100 to 800, 100 to 700, 100 to 600, 100 to 500, 100 to 400 or 100 to 300. In one embodiment, the polyol has a molecular weight of about 200.

In the aforesaid embodiments, the polyol includes polyethylene glycol.

In the aforesaid embodiments, a weight ratio of the pectin to the polyol ranges from 3:1 to 1:3, such as 3:1, 2:1, 1:1, 1:2 or 1:3.

In the aforesaid embodiments, the lithium salt includes at least one selected from the group consisting of lithium bis(trifluoromethanesulfonyl)imide (LiTFSi), LiPF₆, LiClO₄, Li₂SO₄, LiBF₄, LiBOB, LiNO₃, and CH₃COOLi.

Also within the scope of the present invention is a lithium battery, comprising any of the aforesaid gel polymer electrolyte, which can prevent the leakage risk of liquid electrolytes and exhibit excellent battery characteristics. In addition, owing to its hydrolytic properties, the lithium battery of the present invention is advantageous for the subsequent recycling process of lithium battery materials.

In one embodiment, the lithium battery further comprises: a first electrode; a second electrode opposite to the first electrode; and the gel polymer electrolyte disposed between the first electrode and the second electrode.

In the aforesaid embodiment, the first electrode comprises a cathode material selected from the group consisting of lithium cobalt oxide, ternary materials, lithium iron phosphate and a combination thereof. In one embodiment, the cathode material is lithium iron phosphate.

In the aforesaid embodiments, the second electrode is a lithium electrode.

Also within the scope of the present invention is a method for preparing the aforesaid gel polymer electrolyte, comprising the following steps: forming a mixture of pectin, its derivative or a combination thereof, a polyol, and the lithium salt; and performing a cross-linking reaction on the mixture to form the cross-linked composition formed by the pectin, its derivative or a combination thereof, the polyol, and the lithium salt.

In one embodiment, the lithium salt is added into a solution of the polyol and the pectin, its derivative or a combination thereof to form the mixture. In one embodiment, the lithium salt is added into a solution of the polyol and the pectin to form the mixture. Examples of the polyol and the lithium salt are as described above and are not described again here.

In the aforesaid embodiments, a concentration of the lithium salt in the solution is 0.1 M to 1 M, 0.1 M to 0.9 M, 0.1 M to 0.8 M, 0.1 M to 0.7 M, 0.1 M to 0.6 M, 0.1 M to 0.5 M, 0.1 M to 0.4 M, or 0.12 M to 0.38 M.

In the aforesaid embodiments, a weight ratio of the pectin, its derivative or a combination thereof to the polyol ranges from 3:1 to 1:3, such as 3:1, 2:1, 1:1, 1:2 or 1:3.

In the aforesaid embodiments, a thin film of the cross-linked composition is formed after performing the cross-linking reaction. In one embodiment, the thin film is a translucent film. Here, the water in the mixture after performing the cross-linking reaction is removed through evaporation, thereby forming a thin film. In one embodiment, the evaporation time may be, for example, 4 h to 72 h. In one embodiment, the evaporation time may be 5, 8, 10, 24, 48, or 72 h.

In the aforesaid embodiments, the thin film is immersed in an organic solution to remove water. In one embodiment, the thin film is immersed in an ether-containing organic solution to remove water. Examples of the organic solution may comprise at least one selected from the group consisting of 1,3-dioxolane (DOL), dimethoxyethane (DME), ethylene carbonate (EC) and diethyl carbonate (DEC). Herein, the immersing time can be, for example, 12 h to 108 h, such as 12 h, 24 h, 36 h, 48 h, 60 h, or 72 h.

In the aforesaid embodiments, the organic solution may further comprise a supplementary lithium salt. Adding the supplementary lithium salt can control the quality of the thin film.

In the aforesaid embodiments, the supplementary lithium salt may be the same as or different from the lithium salt for forming the cross-linked composition. Examples of the supplementary lithium salt may include at least one selected from the group consisting of LiTFSi, LiPF₆, LiClO₄, Li₂SO₄, LiBF₄, LiBOB, LiNO₃, and CH₃COOLi.

In the aforesaid embodiments, a concentration of the supplementary lithium salt is 0.1 M to 1 M in the organic solution.

At least one characteristic of the method for preparing a gel polymer electrolyte in the embodiments of the present invention is that it requires the addition of both pectin and polyol to react with the lithium salt to produce a gel polymer electrolyte, thereby avoiding the leakage problem caused by liquid electrolytes. If pectin is added to react with the lithium salt, the liquid electrolyte cannot form a gel. Similarly, if only polyol is added to react with the lithium salt, the liquid electrolyte cannot form a gel. Furthermore, if a polymer contains both ester and alcohol functional groups, and only this polymer is added to react with the lithium salt, the liquid electrolyte cannot form a gel.

Different embodiments of the present invention are provided in the following description. These embodiments are meant to explain the technical content of the present invention, but not meant to limit the scope of the present invention. A feature described in an embodiment may be applied to other embodiments by suitable modification, substitution, combination, or separation.

It should be noted that, in the present specification, when a component is described to have an element, it means that the component may have one or more of the elements, and it does not mean that the component has only one of the element, except otherwise specified.

Moreover, in the present specification, a value may be interpreted to cover a range within ±10% of the value, and in particular, a range within ±5% of the value, except otherwise specified; a range may be interpreted to be composed of a plurality of subranges defined by a smaller endpoint, a smaller quartile, a median, a greater quartile, and a greater endpoint, except otherwise specified.

### Production Process of PPLMs for GPEs

First, a solution was prepared by dissolving 0.75 g of pectin and 2.25 g of PEG (molecular weight 200), with a PEC:PEG ratio of 75 wt %, in 14.25 g of deionized water, denoted as PP275. Then, various concentrations of LiTFSi, LiNO₃, and Li₂SO₄ (0.12, 0.25, and 0.38 M) were added to the PP275 solution, resulting in mixtures designated as LTS-012, LTS-025, LTS-038, LNO-012, LNO-025, LNO-038, LSO-012, LSO-025, and LSO038. These mixtures were continuously stirred for 24 h, then cast into Petri dishes and dried in a controlled argon-filled glove box (H₂O<0.01 ppm, O₂<0.01 ppm). The resulting films were precision-cut into 1.6-mm diameter discs, which were immersed in a 1:1 wt % DOL/DME solution with 1 M LiTFSI for a few days.

### Assembling of LFP-PP250∥PPLMs∥Li Half-Cell

CR2032 coin cells were assembled in an ultra-dry, argon-filled glove box (H₂O<0.01 ppm, O₂<0.01 ppm). The cathode, composed of LFP-PP250 (an LiFePO₄-based material with a binder composed of pectin and PEG), was formed into 14-mm discs, while pure lithium metal served as the anode. Ten PPLM variants were named PP275, LTS-012, LTS-025, LTS-038, LNO-012, LNO-025, LNO-038, LSO-012, LSO-025, and LSO-038 as the gel polymer electrolyte disposed between the cathode and the anode.

### Characterization

Electrochemical characterization was conducted using a PARSTAT MC 200 workstation. Galvanostatic charge-discharge profiles were obtained at a constant current of 0.5 C between 2 and 4.2 V vs. Li⁺/Li using the Think Power battery-testing system. Electrochemical impedance spectroscopy (EIS) measurements were performed with an AC amplitude of 10 mV across a frequency range from 100 kHz to 0.5 mHz. The DRT was computed using DRTtools. Tikhonov regularization was applied to the DRT calculations, and the Gaussian method was used for data discretization. The EIS experimental data were fitted using both real and imaginary components, excluding inductive data. A second-order regularization derivative with a regularization parameter of 0.001 was applied, alongside a radial basis function (RBF) with a 0.5 full width at half maximum (FWHM). Each peak corresponds to a distinct electrochemical phenomenon. All tests were conducted at room temperature.

TGA and DSC were employed to evaluate the thermostability and glass transition temperatures of the PPLMs. Samples weighing approximately 12.2±0.3 mg were placed in alumina pans under an argon atmosphere. Thermal analysis was conducted using a Netzsch STA 449 F3 Jupiter instrument under an argon atmosphere with a flow rate of 60 mL/min. The samples were heated at a rate of 5° C. min⁻¹ from 35° C. to 700° C. Nanoindentation tests were conducted using a Hysitron TI 980 TriboIndenter with a Berkovich diamond tip. Each measurement was performed five times at different points. A normal force (P) of 100 μN was applied for 30 s, with the maximum load held for 10 s to minimize viscoelastic effects (creep or relaxation time) of the polymer during unloading. The force was then unloaded over 30 s.

Microstructural analysis was conducted using SEM. A JEOL-Japan JXA-840A instrument was employed for SEM analysis. For a more in-depth investigation of the chemical information, including organic and inorganic elements, XPS was utilized. The analysis was performed using a ULVAC-PHI (Quantes) instrument featuring a dual-scanning X-ray source with mono-chromatic Al Kα (1.4 keV) and Cr Kα (5.4 keV) radiation. The scanning range covers from 7.5 to 1,400 μm.

### Results

Initially, pectin, with its abundant hydroxyl and carboxylic acid functional groups, was combined with PEG owing to its ability to form hydrogen bonds. This interaction promotes the formation of nano-aggregates and subsequently yielded the PP275 polymer blend. Subsequently, lithium salts, including LiTFSI, LiNO₃ or Li₂SO₄, are incorporated into the polymer matrix. This blend undergoes drying and cutting processes to fabricate the pectin/peg with lithium salt membranes (PPLMs), which are then soaked in a liquid electrolyte solution. The membrane structure facilitates ion transport, where PEG acts as a channel for lithium ions while simultaneously restricting the mobility of anions such as TFSI⁻ and NO³⁻. This structural arrangement not only ensures mechanical robustness due to the pectin-PEG framework but also enhances the ionic conductivity essential for efficient battery operation.

The resultant PPLMs are freestanding, demonstrating significant flexibility. The mechanical properties of PPLMs help maintain structural integrity during the demanding fabrication processes and enhance the stability to suppress lithium dendrite growth during cycling. In addition, the membranes exhibit exceptional flexibility, suggesting potential applications in wearable LIBs. Furthermore, these membranes can dissolve in water, proving their environmental friendliness and recyclability.

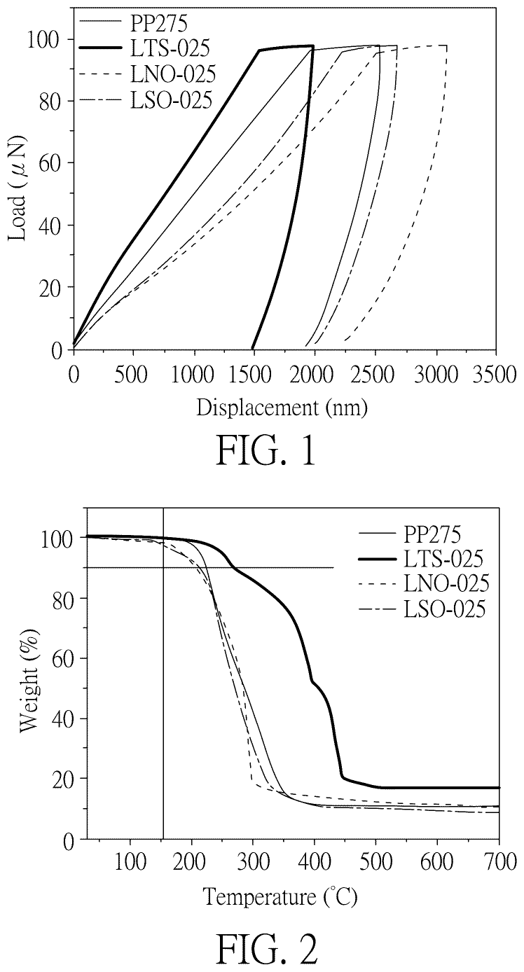

FIG. 1 displays the stress-strain curves of PP275 when combined with different Li salts, which illustrate their mechanical performance. The results reveal that the hardness of the PPLMs increases upon the addition of LiTFSI; on the other hand, the introduction of LiNO₃ or Li₂SO₄ results in an enhancement of its flexibility. The greater flexibility of GPEs enhances their ionic conductivity, making these flexible materials advantageous for battery applications. The observed variations in the mechanical properties of the PPLMs can be attributed to the interaction between the Lit ions and polymer chains in PP275. The mechanical parameters, including maximum depth (hₘₐₓ), hardness (H), and elastic modulus (E), are listed in Table 1.

TABLE 1

| | Maximum depth | Hardness | Elastic modulus |
|---|---|---|---|
| Sample | hmax (nm) | H (MPa) | E (GPa) |
| PP275 | 2544.229851 | 0.776 | 20.446 |
| LTS-025 | 1560.512006 | 2.093 | 47.267 |
| LNO-025 | 3092.283913 | 0.567 | 12.334 |
| LSO-025 | 2679.087897 | 0.744 | 18.687 |

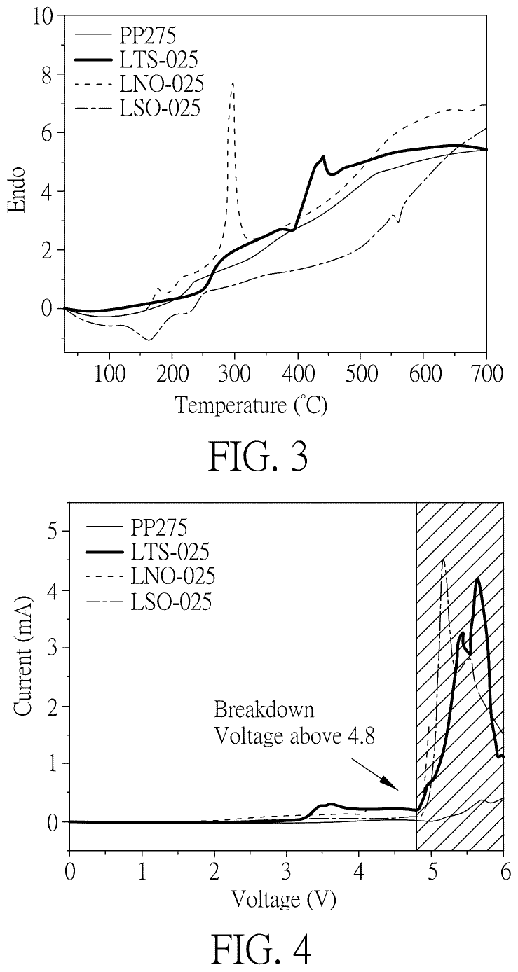

The primary security risk in LIBs stems from the formation of combustible organic gases. The ability of GPEs to retain the liquid electrolyte is essential for preventing the release of these gases from the electrolyte under thermal stress. The efficacy of a GPE at high temperatures correlates with its ability to retain the liquid electrolyte. We use thermal gravimetric analysis (TGA) differential scanning calorimetry (DSC) (TG-DSC) to assess GPEs' electrolyte retention properties. As shown in FIG. 2, with the PPLMs, liquid solvents begin to evaporate at around 200° C., which coincides with the boiling point of PEG. This behavior is consistent with the picture of the contents being gelled and retained within the matrix and the interconnections of the gel composite membrane. In composites containing PEG/pectin and lithium salts, the addition of PEG enhances the thermal stability, while pectin may interact with lithium salts. Due to complex formation and interactions within these composites, this may lead to premature degradation of the composite or changes in its thermal stability. In composites with LiNO₃, TGA and DSC analyses displayed a pre-melting phenomenon, showing a solid-solid transition peak at 180° C. before melting. When the temperature reaches 200° C., approximately 90% of the electrolyte is still contained within the gel composite membrane, indicating that the PPLM performs effectively within this temperature range. Furthermore, even not shown in the figure, the membrane containing LiNO₃ begins to thermally decompose, possibly releasing N₂O and O₂, which is also observed in the DSC curves for the samples shown in FIG. 3. TGA results clearly demonstrate that no more liquid remains in all PPLMs. The DSC data do not display any noticeable changes in the baseline, indicating the absence of a glass transition temperature (Tg) within the analyzed temperature range. This observation further confirms the thermal stability of PPLMs, making them suitable candidates for use as electrolytes or separator components in electrochemical devices.

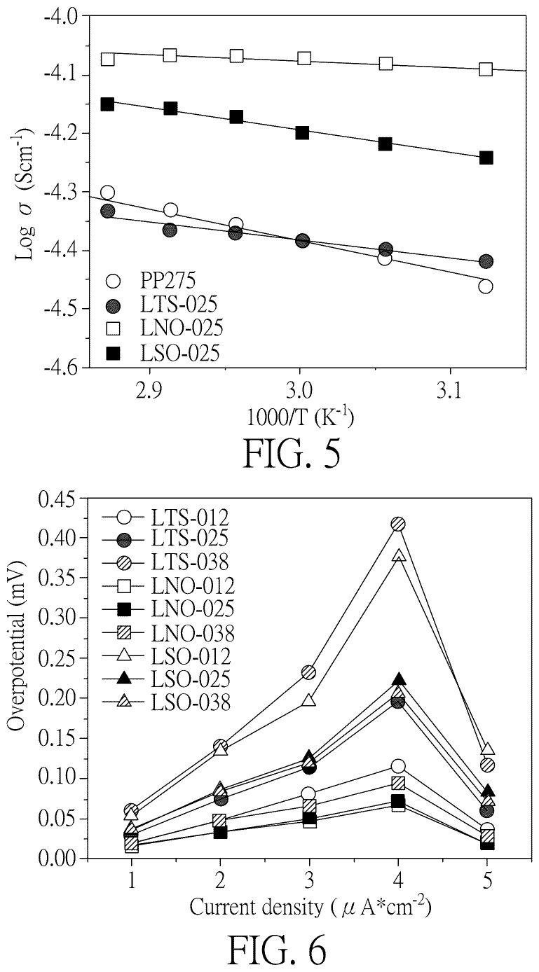

Following our initial evaluations, linear sweep voltammetry (LSV) was used to determine the oxidative stability of the PPLMs. As shown in FIG. 4, these PPLMs demonstrate an oxidation potential of approximately 4.80 V (vs. Li⁺/Li). This notable potential is primarily attributed to the degradation of the PEG brushes, induced by the damage of free carbon radicals occurring around 4.7 V. The noticeable onset for LTS-012 degradation occurs at much lower voltages, specifically below 4 V versus Li/Li⁺. It was detected that the deprotonation of —OH groups begin at 3.2 V, resulting in the formation of the strong acid bis(trifluoromethanesulfonyl)imide triflimide (HTFSI), which subsequently affects the pectin/PEG ether main chain. Subsequent measurements were conducted to assess the ionic conductivities of PPLMs across a temperature range of 45° C.-85° C. Nyquist plots (not shown in the figure) reveal that the ionic conductivities of PP275, LTS-025, LNO-025, and LSO-025 are 3.46×10⁻⁴, 4.21×10⁻⁴, 8.14×10⁻⁴, and 5.73×10⁻⁴ S cm−1 at 45° C., respectively. Additionally, Arrhenius plots, which illustrate the temperature dependence of ionic conductivity, are presented in FIG. 5. The results reveal that lithium-ion transport typically follows two predominant conduction mechanisms, which are characterized by Vogel-Tammann-Fulcher (VTF) behavior and Arrhenius behavior. The linear curve typically exhibits Arrhenius behavior, with the activation energy (Ea) calculated for PP275, LTS-025, LNO-025, and LSO-025 at 4.42, 2.57, 0.85, and 3.19 J mol−1, respectively. This reduced Ea value, especially in the LNO-025 case, suggests that the migration and dispersion of Lit ions in batteries face fewer barriers.

Symmetric Li cells (Li∥PPLMs∥Li) were assembled to evaluate the electrochemical compatibility of PPLMs with lithium metal during the plating/stripping processes at current densities of 0.05, 0.1, 0.15, and 0.2 mA cm⁻², and then returning to 0.05 mA cm 2. The voltage curves with increasing current are shown in FIG. 6. According to the cycling performance of symmetric Li∥PPLMs∥Li cells, the PP275 (not shown in the figure), cell exhibits a relatively high polarization voltage of 22 m V during the initial cycles, which increases with the increasing applied current, showing extreme instability at 0.2 mA cm⁻². Upon reverting to 0.05 mA cm 2, a brief stabilization is achieved before an inner short circuit occurred at 380 h, likely due to the excessive accumulation of dead lithium. In contrast, initial formulations of PPLMs enhanced with lithium salts demonstrates lower overpotential for LTS-025, LNO-025, and LSO-025, measured at 15, 9, and 20 m V, respectively, under a current density of 0.05 mA cm⁻². Upon returning to 0.05 mA cm⁻², the change in overpotential is smallest for LNO-025, indicating its superior compatibility with lithium metal. The LNO-025 membrane cell shows exceptional reversibility in the lithium plating/stripping processes.

The mobility of anions and low ion diffusivity in lithium-ion-conducting polymer electrolytes lead to pronounced concentration polarization, low lithium-ion transference number, and diminished discharge capacity. Therefore, accurately determining the lithium-ion transference number is critical for assessing the cation mobility in LIBs. We used the steady-state current method for this measurement. The lithium-ion transference numbers for the PPLM-LTS-025, LNO-025, and LSO-025 are determined to be 0.24, 0.34, and 0.18, respectively. These data clearly indicate typical ion conduction behavior for GPEs, generally ranging between 0.2 and 0.5 within these membranes. On the other hand, the compatibility of the GPE with Li metal was evaluated. The voltammetry curves reveal that all samples display a pair of cathodic and anodic peaks around 0 V, corresponding to the reduction and oxidation processes of lithium. Notably, the cathodic and anodic peaks of LNO-025 are the most prominent. Better symmetry in peak shape and position signifies a higher reversibility in lithium deposition and dissolution on the electrode surface. This improved reversibility is highly beneficial for the charge-discharge and cycling performance of the battery.

The enhancement in the Lit transference number may lead to an advantage in reducing the dendritic features. The SEM images of the Li-metal surface after 100 cycles (not shown in the figure) indicated that cells with LTS-025 and LSO-025 GPE exhibit a rough morphology with visible cracks on the surface. In contrast, cells with LNO-025 GPE show the formation of molten-like particles. Notably, the surface of the LNO-025 appears smoother than those of LTS-025 and LSO-025. A significant contributing factor is the Li⁺ transference number of LNO-025, which helps delay the onset of dendrite formation that restricts the free migration of anions. This leads to more uniform lithium deposition, enhancing the overall stability of the lithium-metal surface. Furthermore, we used X-ray photoelectron spectroscopy (XPS) to analyze the surface condition of the Li metal after cycling. In the C Is spectra, all samples exhibit CO₃ or C—F signals, confirming the formation of the SEI layer. According to the O 1s and C 1s data, the SEI layers formed on LSO-025 and LTS-025 appear to be more polymer-like, containing unstable Li alkoxides and Li carbonates. In contrast, no CO₃ signal was detected in the SEI layer of LNO-025, suggesting that its SEI layer is primarily composed of C—F with minimal carbonate-based elements. This composition predicts that LNO-025 will demonstrate better long-cycle performance, as Li carbonates have poor ionic conductivity and can easily promote dendrite formation. Additionally, the thinner SEI layer in LNO-025, with its flexible mechanical properties, is better suited to accommodate 300% volume expansion.

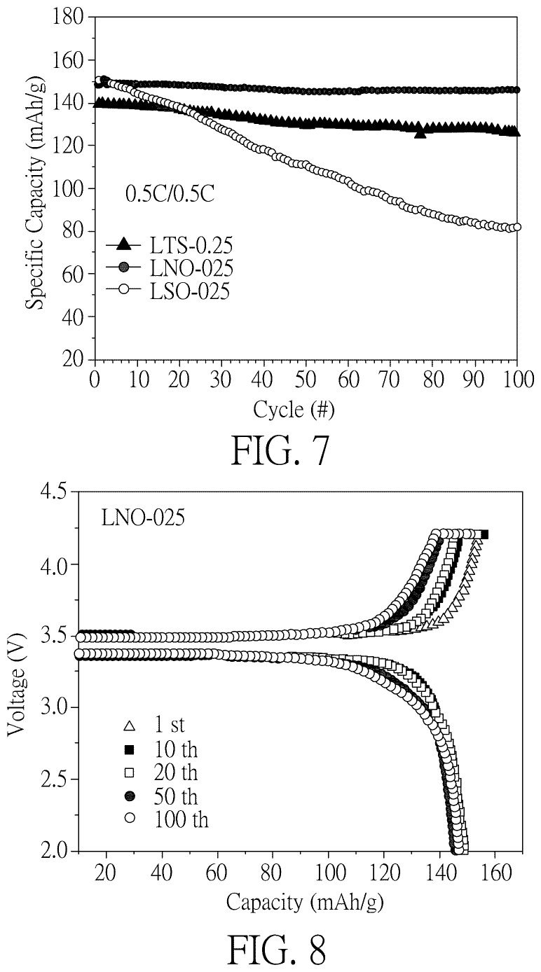

The addition of lithium salts evidently enhances these parameters, particularly the performance of LNO-025. Consequently, we carried out experiments to examine the quasi-solid cell performance (Li∥PPLMs∥LFP) using salt-containing PPLMs. FIG. 7 presents the cycling performance of LTS-025, LNO-025, and LSO-025 membranes, tested at a 0.5 C rate between 2.0 and 4.2 V. All the samples display stable performance throughout the cycling process. The LNO-025 membrane exhibits the best cycling stability, achieving a discharge specific capacity of 148.5 mAh g⁻¹ by the 10th cycle and maintaining a capacity of 146.4 mAh g⁻¹ after 100 cycles. LTS-025 and LSO-025 also demonstrate respectable cycling performances, with discharge capacities of 138.7 and 143.8 mAh g⁻¹ at the 10th cycle and 125.7 and 81.9 mAh g⁻¹ after 100 cycles, respectively. The results of lithiation/delithiation performance (not shown in the figure) show that LTS-025 and LSO-025 maintain relatively fluctuating charge-discharge plateaus. Specifically, FIG. 8 shows that the LNO-025 charge-discharge curve consistently overlaps through 100 cycles. An initial irreversible reaction in the LTS-025, LNO-025, and LSO-025 membranes with the LFP electrode to be 11.4, 10.2, and 12.2 mAh g⁻¹, respectively (not shown in the figure). This further confirms that LNO-025 possesses exceptional electrochemical reactivity and cycling resilience.

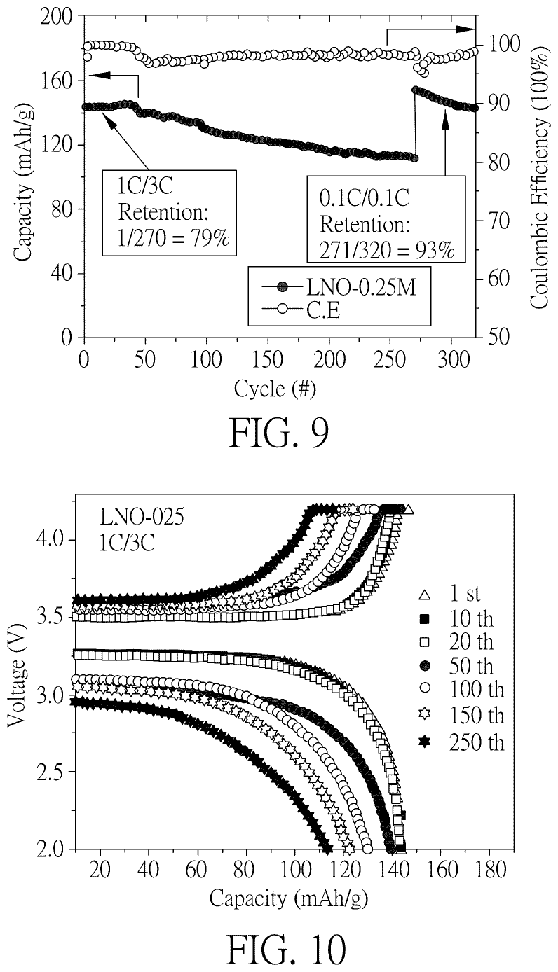

The impressive 0.5 C-rate performance of the LNO-025 cell is closely linked to its low polarization effects, high ionic conductivity, and elevated lithium-ion transference number. We further assessed the high-rate charge-discharge capabilities of LNO-025, as shown in FIG. 9 to FIG. 11, where long-term stability tests were conducted under 1 C/3 C charge/discharge rates, returning to 0.1 C/0.1 C. The LNO-025 exhibits a specific capacity of 143.7 mAh g⁻¹ at the first cycle under 1 C/3 C conditions, which has a remarkable retention exceeding 79% at 111.5 mAh g⁻¹ after 270 cycles. Furthermore, when returned to 0.1 C/0.1 C, the capacity retains to 153.5 mAh g⁻¹. Although signs of degradation were observed, after 50 cycles the capacity still reached 142.3 mAh g⁻¹, with a retention of 93%, suggesting a different ion conduction mechanism in the LNO-025 membrane after such rigorous cycling tests. Throughout the process, the Coulombic efficiency consistently remains close to 99%.

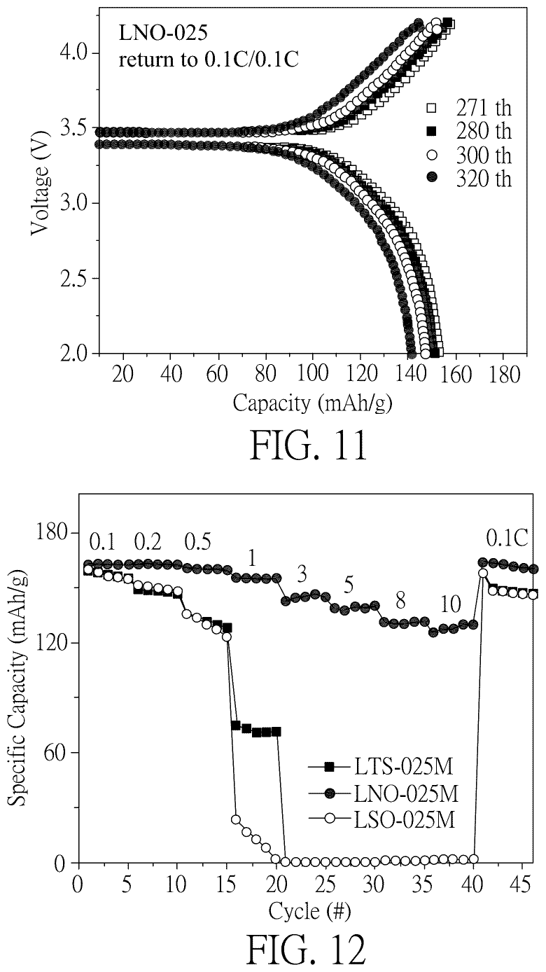

To better understand the rate performance of the PPLMs, the half-cell charge processes were examined within a voltage range of 2.0-4.2 V versus an Li/Lit reference with a consistent charging rate maintained at 0.1 C. This was followed by a series of discharging rates from 0.1 C to 10 C before returning to 0.1 C; the results are displayed in FIG. 12, Uniform capacity retention was observed for all samples at the baseline C rate of 0.1 C. Compared to the other membranes, again, the LNO-025 membrane demonstrates the most commendable performance. When subjected to charge-discharge rates exceeding 1 C, both LTS-025 and LSO-025 batteries experienced rapid degradation. However, when the rate was fixed back at 0.1 C, these batteries appeared to regain functionality. The LNO-025 demonstrated discharge capacities of 126 mAh g⁻¹ at 10 C. This indicates that the LNO-025 coupled with LFP cathode performs extremely well, achieving a power density close to 4.1 kW kg⁻¹. This value is close to that of liquid electrolytes and is much better than the existing reported values on GPEs. We further estimate the potential energy density achievable based on the LNO-025 GPEs. Using the LFP as active cathode material with Li metal as counter electrode, after incorporating the LNO-025 GPE, the energy density is 345 Wh kg⁻¹. Using the commercial 18650 cell format, we obtain an energy density of 146 Wh kg⁻¹, which is at least 30% higher than the values claimed in the Lithium Werks (112 Wh kg⁻¹) and A123 (91 Wh kg⁻¹) products.

The volume change of the active material within the cathode during charging and discharging can significantly affect the electrochemical performance. This effect is especially prominent in cells that use solid or gel electrolytes. During cycling, the mechanical stress at the electrode/electrolyte interface due to these volume changes can lead to detachment of the active material from the GPEs. Subsequently, the interface resistance increases to result in greater internal polarization of the battery. To better understand this effect, we analyzed the impedance data of LTS-025, LNO-025, and LSO-025 using the color-mapped distribution of relaxation time (DRT) and Bode plots during the charging and discharging processes (data not shown). The LTS-025 and LSO-025 cells exhibit oscillating ripples from the high- to low-frequency regions, whereas LNO-025 shows a consistent pattern across these frequency ranges. This suggests that the flexibility of LNO-025 (FIG. 3) effectively suppresses volume changes at the interface, thereby enhancing the lithium-ion transport properties. The signatures observed in the high- and medium-frequency ranges correspond to bulk resistance and the resistance of passivation layers, such as cathode-electrolyte-interphase (CEI) and solid-electrolyte-interphase (SEI) films, whereas low-frequency signatures are associated with charge transfer resistance across the LFP/GPE interface. In our study, the LNO-025 cell exhibits a strong resistive response, attributed to good adhesion at the interface between the electrode and the GPE. Conversely, the LTS-025 and LSO-025 cells show a higher capacitive response, which can be linked to poorer electrode/GPE interfacial contact.

Our work has developed a new type of environmentally friendly pectin-/PEG-based GPE incorporating different lithium salts (LiTFSI, LiNO₃, and Li₂SO₄) to examine the electrochemical performance of batteries. Our results show that the flexible pectin-/PEG-based GPE containing LiNO₃ provides the best electrochemical performance. In addition, it also demonstrates excellent water solubility that facilitates battery recycling with significant reduction in environmental impact. More detailed electrochemical tests show that the LiNO₃-based GPE has a higher Lit transference number, which leads to excellent interfacial stability and electrolyte retention. Thermal analysis indicated that the GPE maintained its structural integrity up to 200° C. Through LSV tests, the GPE was confirmed to have an oxidative stability window up to 4.8 V, enabling support for high-voltage applications. Specifically, LNO-025, when used in a quasi-solid cell configuration with LFP as the cathode, achieved an initial capacity of 148.5 mAhg⁻¹ at a 0.5 C rate and maintained a high capacity of 146.4 mAhg⁻¹ after 100 cycles, demonstrating a retention of 98.5%, which indicates excellent cycle stability. It also performed well under high current densities of 1 C/3 C rate, retaining 79% capacity after 270 cycles, and demonstrated impressive C-rate performance. A major highlight of this work is that selecting the appropriate lithium salt additive is crucial for optimizing battery performance. XPS analysis and DRT color mapping support that LiNO₃ effectively improves the formation of the SEI layer and enhanced the charge/discharge stability of the battery. These results provide important references for the future application of LIBs and lay a solid foundation for further development of GPE technology in the field of energy storage and high-performance quasi-solid battery systems.

In view above, the potential of a new biopolymer GPE that utilizes the synergistic properties of pectin (a biopolymer composed of D-galacturonic acid) and biodegradable PEG in conjunction with lithium salts are examined. In addition to the role of salts in enhancing ionic conductivity, both pectin and PEG play critical roles in shaping the mechanical and thermal properties of GPE. Pectin, with its natural polysaccharide structure (cellulose, alginate, pectin, etc.), contributes to mechanical strength and stability, helping GPEs resist degradation. Meanwhile, PEG functions as a plasticizer, improving ion dissociation of lithium salts, lowering the viscosity of the polymer matrix, and enhancing flexibility to accommodate electrode volume changes during cycling. This combination of the rigidity of natural polysaccharide and the flexibility of PEG results in an interconnected matrix that supports ion transport while preserving structural integrity. More intriguingly, the pectin/PEG GPEs not only show improved electrical performance but also dissolve readily in water, facilitating battery recycling and reducing the environmental impact. This investigation into the electrochemical performance of pectin-/PEG-based GPEs emphasizes the potential foundational aspects and the advancements for eco-friendly development in the realm of gel polymer electrolytes.

Although the present disclosure has been explained in relation to its embodiment, it is to be understood that many other possible modifications and variations can be made without departing from the spirit and scope of the disclosure as hereinafter claimed.

1. A gel polymer electrolyte, comprising:
a cross-linked composition formed by pectin, its derivative or a combination thereof; a polyol; and a lithium salt.

2. The gel polymer electrolyte of claim 1, wherein the cross-linked composition formed by the pectin; the polyol; and the lithium salt.

3. The gel polymer electrolyte of claim 1, wherein the polyol includes polyethylene glycol.

4. The gel polymer electrolyte of claim 1, wherein a weight ratio of the pectin to the polyol ranges from 3:1 to 1:3.

5. The gel polymer electrolyte of claim 1, wherein the lithium salt includes at least one selected from the group consisting of lithium bis(trifluoromethanesulfonyl)imide (LiTFSi), LiPF₆, LiClO₄, Li₂SO₄, LiBF₄, LiBOB, LiNO₃, and CH₃COOLi.

6. A lithium battery, comprising the gel polymer electrolyte of claim 1.

7. The lithium battery of claim 6, further comprising:
a first electrode;
a second electrode opposite to the first electrode; and
the gel polymer electrolyte disposed between the first electrode and the second electrode.

8. The lithium battery of claim 7, wherein the first electrode comprises a cathode material selected from the group consisting of lithium cobalt oxide, ternary materials, lithium iron phosphate and a combination thereof.

9. The lithium battery of claim 7, wherein the second electrode is a lithium electrode.

10. A method for preparing the gel polymer electrolyte of claim 1, comprising the following steps:
forming a mixture of pectin, its derivative or a combination thereof, a polyol, and the lithium salt; and
performing a cross-linking reaction on the mixture to form the cross-linked composition formed by the pectin, its derivative or a combination thereof, the polyol, and the lithium salt.

11. The method of claim 10, wherein the lithium salt is added into a solution of the polyol and the pectin, its derivative or a combination thereof to form the mixture.

12. The method of claim 11, wherein a concentration of the lithium salt in the solution is 0.1 M to 1 M.

13. The method of claim 11, wherein a weight ratio of the pectin, its derivative or a combination thereof to the polyol ranges from 3:1 to 1:3.

14. The method of claim 10, wherein a thin film of the cross-linked composition is formed after performing the cross-linking reaction.

15. The method of claim 14, further comprising a step of: removing water after forming the thin film.

16. The method of claim 15, wherein the thin film is immersed in an organic solution to remove water.

17. The method of claim 16, wherein the organic solution comprises at least one selected from the group consisting of DOL, DME, EC and DEC.

18. The method of claim 16, wherein the organic solution further comprises a supplementary lithium salt.

19. The method of claim 18, wherein a concentration of the supplementary lithium salt is 0.1 M to 1 M in the organic solution.
